(19) United States
(12) Patent Application Publication
(10) Pub. No.: US 2026/0133381 A1
(43) Pub. Date: May 14, 2026

(54) OPTICAL COUPLER FOR PHOTONIC INTEGRATED CIRCUITS

(71) Applicant: Xilinx, Inc., San Jose, CA (US)

(72) Inventors: Hao-Hsiang Liao, San Jose, CA (US); Chuan Xie, San Jose, CA (US); Fang-Yu Liang, Hsinchu City (TW); Suresh Ramalingam, San Jose, CA (US)

(73) Assignee: Xilinx, Inc., San Jose, CA (US)

(21) Appl. No.: 18/941,171

(22) Filed: Nov. 8, 2024

(51) Int. Cl. G02B 6/42

(52) U.S. Cl. CPC G02B 6/4214

(57) ABSTRACT

Techniques are described for the use of optical couplers with photonic integrated circuits (PICs). Some techniques include optically coupling one device (e.g., a package) to another via one or more optical couplers to, for instance, optically couple an on-chip waveguide to an off-chip optical fiber. Some techniques do not require careful alignment of a waveguide with a lens or other components, and are scalable to large numbers of optical paths. Moreover, some optical couplers herein may be fabricated with known (e.g., conventional) wafer-level processes.

### BACKGROUND

Whereas electronic integrated circuits use electrons to transport information, photonic integrated circuits instead utilize light to transport information within the circuit. Some devices, such as co-packaged optics (CPOs), include both electronic and photonic integrated circuits on a single packaged substrate. Because photonic circuits do not generate heat to the same extent as electrical circuits, photonic devices may provide a more energy efficient way to provide high-frequency signals between devices. For instance, deploying CPOs and other circuits with photonic components in data centers may reduce the energy consumption needed for cooling.

### BRIEF DESCRIPTION OF DRAWINGS

The accompanying drawings illustrate a number of exemplary implementations and are a part of the specification. Together with the following description, these drawings demonstrate and explain various principles of the present disclosure.

FIG. 1 depicts a top view of a portion of a device that includes photonic integrated circuit components, according to some embodiments;

FIG. 2A depicts a top view of a portion of a device that includes an optical coupler and a PIC, according to some embodiments;

FIG. 2B depicts a cross-sectional view of the device shown in FIG. 2A;

FIGS. 2C and 2D depict cross-sectional views of two different implementations of the optical coupler of FIGS. 2A and 2B, according to some embodiments;

FIG. 3A depicts a top view of an optical coupler, according to some embodiments;

FIGS. 3B and 3C depict cross-sectional views of the optical coupler of FIG. 3A, according to some embodiments;

FIG. 4 depicts a cross-sectional view of an illustrative system that includes two optical couplers that optically couple together multiple photonic components, according to some embodiments;

FIG. 5 depicts an example of arranging suitable connector housings around the elements of the system of FIG. 4, according to some embodiments;

FIG. 6A depicts a top view of a device that includes multiple waveguides and respective concave, reflective surfaces as part of an optical coupler, according to some embodiments;

FIG. 6B depicts a cross-sectional view of an optical coupler as shown in FIG. 6A, according to some embodiments; and

FIG. 7 is a flowchart of a method of coupling two optical devices, according to some embodiments.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

Described herein are various examples of optical couplers for use with photonic integrated circuits (PICs). For example, techniques are described for optically coupling one device (e.g., a package) to another device via one or more optical couplers. Some such techniques may be applied to optically couple an on-chip waveguide to an off-chip optical fiber. Some techniques may not require active alignment of a waveguide with a lens or other components, and may be scalable to large numbers of optical paths. For example, some optical coupling techniques described herein may be employed to optically couple tens or hundreds of waveguides on a single device to respective separate devices (e.g., optically couple many on-chip waveguides to respective off-chip optical fibers). Moreover, some optical couplers described herein may be fabricated with known (e.g., conventional) wafer-level manufacturing processes.

According to some embodiments, an optical coupler on a package may be arranged in proximity to an optical coupler on a device external to the package, allowing light to be transmitted from the package to the other device. For instance, light propagating through a waveguide in a PIC may be reflected by a first optical coupler onto a second optical coupler arranged within an external device that is mechanically coupled to the PIC (e.g., attached via a plug). Light incident on the second optical coupler may be reflected into the external device, thereby allowing the light to pass from the PIC to the external device. Similarly, light may be transmitted the opposite direction from the external device into the PIC via the second optical coupler and first optical coupler. In some embodiments, an external device may be removably connectable to the PIC via a plug that may be inserted into, and removed from, a portion of the PIC housing. The plug and housing may be arranged so that fully inserting the plug aligns the optical coupler on the PIC with the optical coupler in the external device.

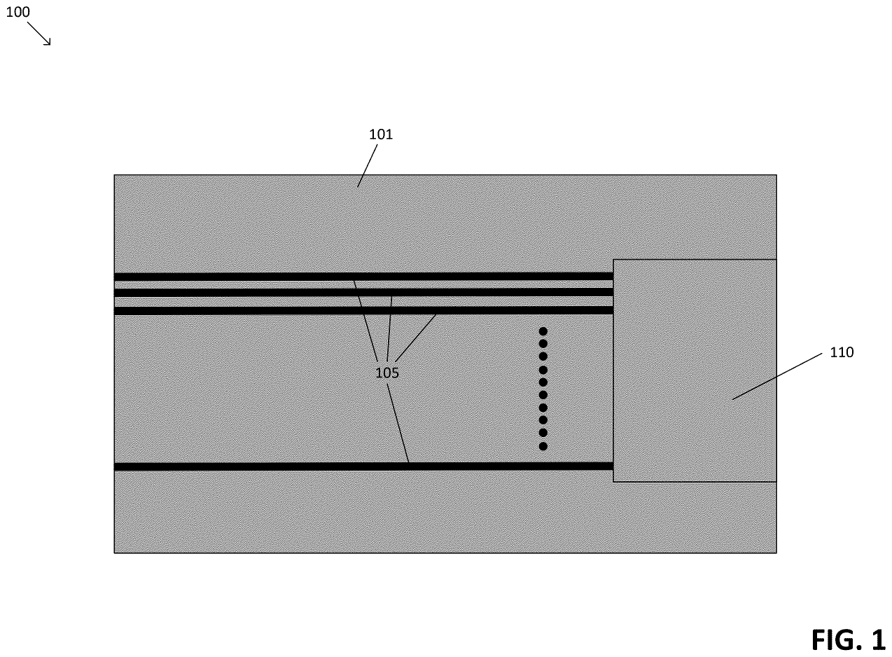

As an illustrative example of the type of device in which the techniques described herein may be deployed, FIG. 1 depicts a top view of a portion of a device that includes photonic integrated circuit components, according to some embodiments. In the example of FIG. 1, device 100 includes a substrate 101 (e.g., a die) in which a plurality of waveguides 105 are formed. The vertical line of dots in FIG. 1 indicates that there could be a large number of waveguides, though only four waveguides are shown in the drawing. Device 100 also includes a cavity (which may also be referred to as a trench) 110 at a terminal end of the waveguides. Device 100 may represent a portion of a device where light from photonic integrated circuit (PIC) components is to be conveyed to another device, or at least to another substrate.

According to some techniques described herein, an optical coupler may be arranged at least partially within the cavity 110 and may comprise at least one concave, reflective surface facing an end of at least one of the waveguides 105 (i.e., to the left in FIG. 1) and also facing away from the substrate (i.e., out of the page in FIG. 1). As a result, light emitted from the end of a waveguide may be reflected upwards from the substrate (out of the page in FIG. 1) to allow for the light from the waveguide to be received by another device separate from the substrate 101. This may, for instance, allow for transmission of the light away from the substrate 101 (e.g., via an optical fiber), and/or may allow for testing of PIC components during wafer-level testing. The optical coupler may be arranged on the substrate 101 and at least partially within the cavity, and may be aligned to the waveguide(s) via various features formed on the substrate and/or optical coupler, examples of which are described below.

An optical coupler described herein may be considered as being provided over an existing PIC, or may be considered to be an integral part of a PIC, as the techniques described herein are not dependent on which components are considered to be part of, or separate from, a PIC. Hereinafter, an optical coupler may be referred to as being distinct from a PIC for purposes of explanation, but should not be seen as limiting the optical coupler as being a component separate from the PIC.

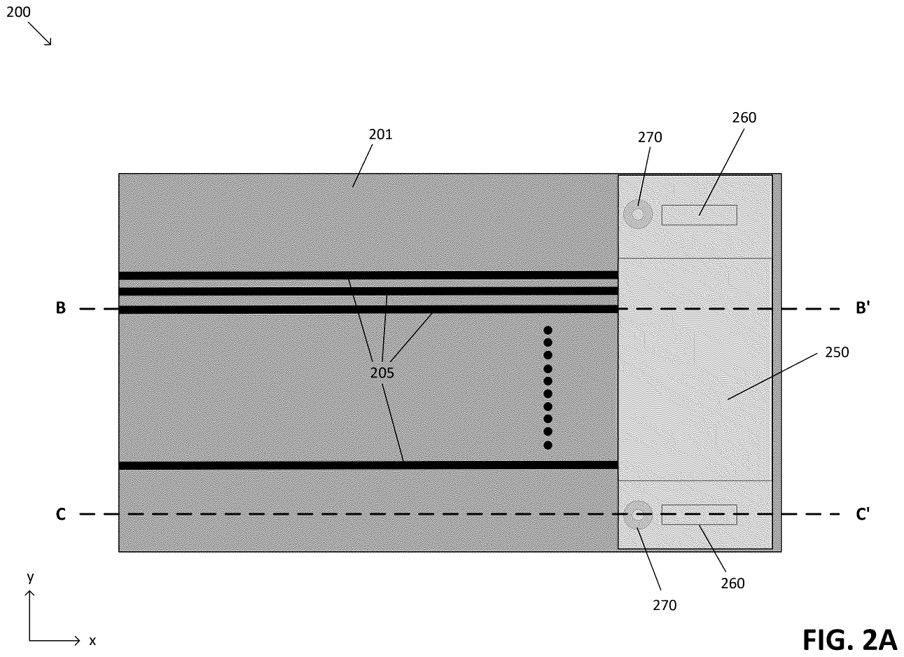

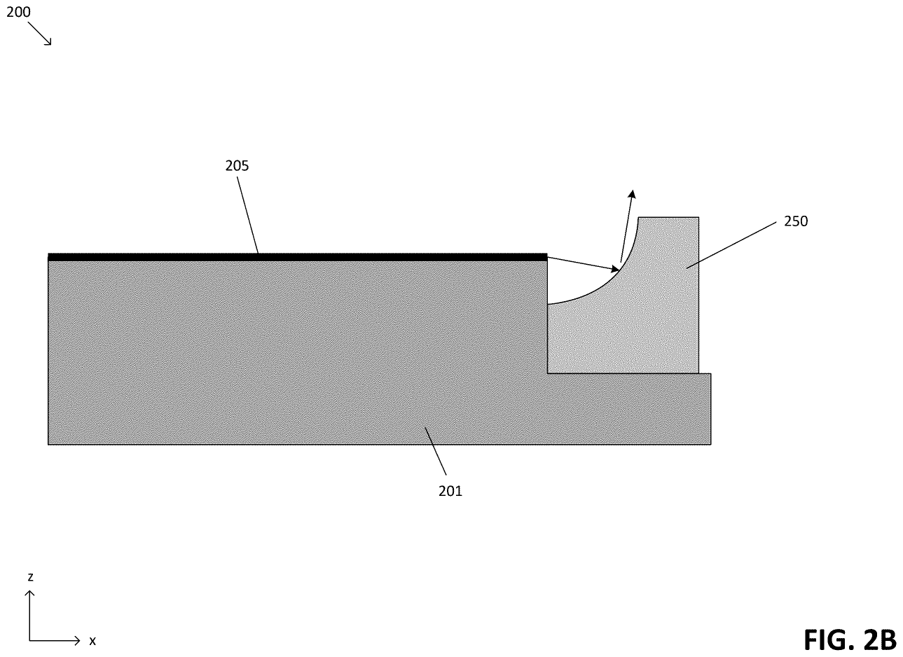

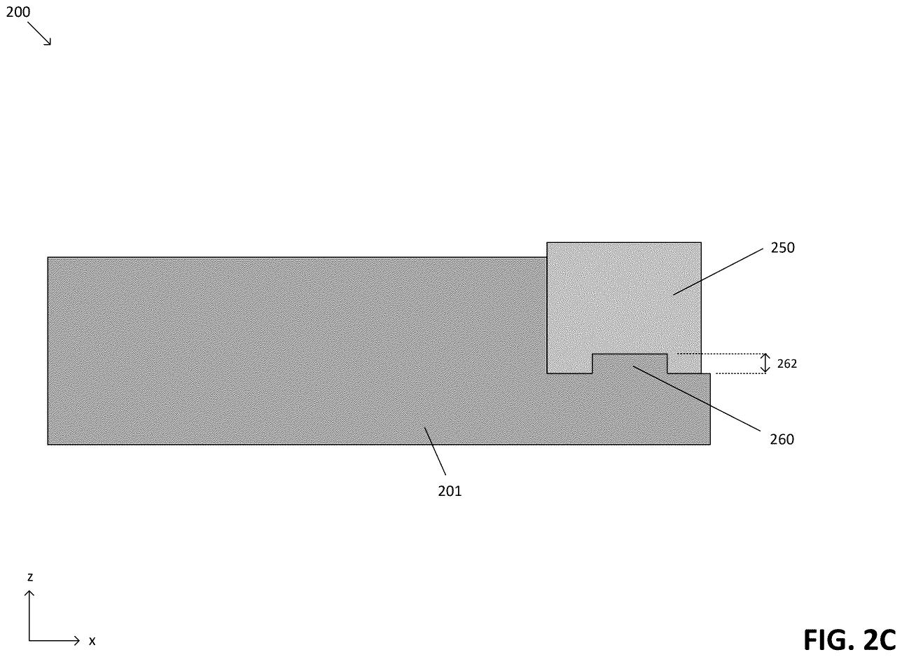

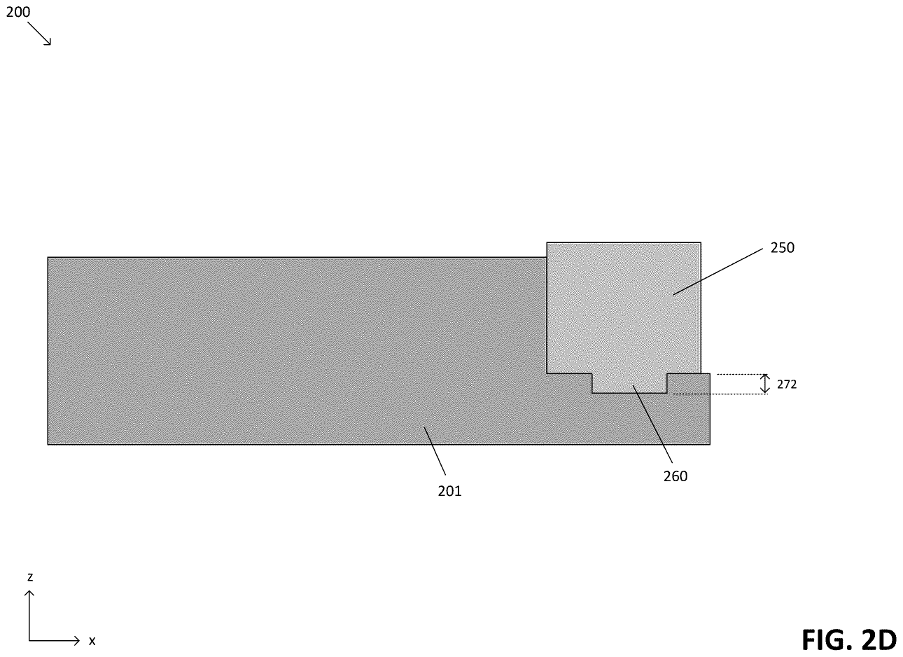

FIG. 2A depicts a top view of a portion of a device that includes an optical coupler and a PIC, according to some embodiments. FIGS. 2B and 2C depict cross-sectional views of the device shown in FIG. 2A through cross-sections B-B′ and C-C′ respectively.

In the example of FIGS. 2A-2C, device 200 includes a substrate 201 in which a plurality of waveguides 205 are formed. The waveguides may be formed with a square or rectangular cross-section taken along the y-axis (as shown in FIG. 2A). The vertical line of dots in FIG. 2A represents that there could in general be any number of waveguides, although only four waveguides are shown in the drawing. Device 200 includes optical coupler 250 arranged within a cavity at a terminal end of the waveguides.

During operation of the device 200, light propagating through a waveguide 205 may be emitted from the end of the waveguide, where the waveguide meets the cavity formed in the substrate. For instance, the light propagating through the waveguide 205 may be emitted from an aperture, or from a tapered structure such as a spot size converter (SSC) at the end of the waveguide. The light may be reflected from a concave, reflective surface of the optical coupler 250 away from the substrate, as shown in FIG. 2B by the illustrative arrows depicting an example beam path from the waveguide onto the optical coupler, and reflected upwards. More specifically, the light may be directed at least partially in the z-direction (see the axes at the lower-left of FIG. 2B).

In some embodiments, the optical coupler 250 may be configured to collimate the light incident on the coupler. In some cases, light from the waveguide is divergent when it exits the waveguide (e.g., exits a spot size converter), and the surface shape of the optical coupler, as well as the position of the coupler, may be selected to reduce the divergence and collimate the light. For example, the concave reflective surface of the optical coupler may have the shape of a spherical section and may function like a collimating mirror. Moreover, in some embodiments the optical coupler may be configured to increase the beam size of the light. For instance, a concave reflective surface, such as a spherical mirror (e.g., having the shape of a piece cut out of a spherical surface) may produce a collimated beam of light with a larger beam size than the light emitted from the waveguide. An optical coupler may additionally or alternatively comprise concave surface that are not spherical. In some embodiments, the optical coupler may be configured so that the beam size reflected from the concave, reflective surface of the optical coupler is between 5 and 20 times the beam size of the light emitted from the waveguide (e.g., from a spot size converter). This increase in beam size may be beneficial to increase the mechanical tolerances for alignment of elements with the optical coupler 250.

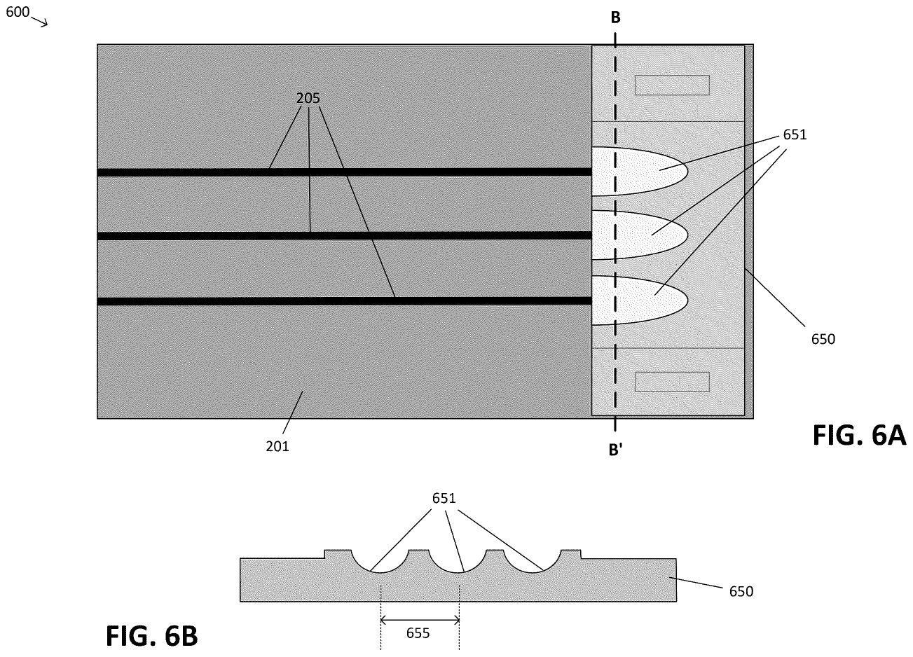

According to some embodiments, optical coupler 250 may include a plurality of distinct concave reflective surfaces that are each positioned and shaped to separately reflect light emitted from the aperture of each of the waveguides 205. An example of such a configuration is shown in FIGS. 6A-6B and described below.

In the example of FIG. 2A-2C, a pair of features 260 are formed on top of, or as an integral part of, the substrate 201. The features 260 in the substrate may include a pedestal and/or a recess, with corresponding mating features formed on the underside of the optical coupler 250. Where the features 260 include a pedestal, as shown in FIG. 2C, a corresponding recess in the optical coupler may be sized larger in the x- and y-directions than the corresponding pedestal, allowing each pedestal to protrude into the recess when the optical coupler is arranged over the substrate. Where the features 260 include a recess in the substrate, as shown in FIG. 2D, the recess in the substrate may be sized larger in the x- and y-directions than a corresponding protrusion in the optical coupler, allowing the protrusion to be seated in the recess when the optical coupler is arranged over the substrate.

The features 260 may allow for alignment of the optical coupler in the z-direction, as the height of the pedestal may dictate the z-position of the optical coupler 250 once it is arranged over the corresponding mating feature.

In some embodiments, a height of the pedestal in the z-direction 262 in the example of FIG. 2C is greater than or equal to 2 μm, 5 μm, 6 μm, 7 μm, 8 μm, 9 μm, 10 μm, or 15 μm. In some embodiments, a height of the pedestal in the z-direction 262 is less than or equal to 20 μm, 15 μm, 10 μm, 9 μm, 8 μm, 7 μm, 6 μm, or 5 μm. Any suitable combinations of the above-referenced ranges are also possible (e.g., a height of the pedestal in the z-direction 262 is greater or equal to 5 μm and less than or equal to 10 μm, etc.).

In some embodiments, a height of the recess in the z-direction 272 in the example of FIG. 2D is greater than or equal to 2 μm, 5 μm, 6 μm, 7 μm, 8 μm, 9 μm, 10 μm, or 15 μm. In some embodiments, a height of the recess in the z-direction 272 is less than or equal to 20 μm, 15 μm, 10 μm, 9 μm, 8 μm, 7 μm, 6 μm, or 5 μm. Any suitable combinations of the above-referenced ranges are also possible (e.g., a height of the recess in the z-direction 272 is greater or equal to 5 μm and less than or equal to 10 μm, etc.).

It may be appreciated that while the features 260 are shown in the examples of FIGS. 2A-2D as being arranged alongside the curved portion of the optical coupler 250, other geometries for the optical coupler may also be envisioned in which the optical coupler comprises features at other locations. For instance, the optical coupler may have a U-shaped cross section when viewed in the view of FIG. 2A, such that the optical coupler has portions that extend on top of the substrate on either side of the waveguides 205, in which case the features 260 may be arranged within these portions on either side of the waveguides.

In the example of FIGS. 2A-2C, fiducial marks 270 may be produced on the substrate 201 and also on the optical coupler 250 to assist in aligning the optical coupler along the x- and y-axes. While the pedestal may limit movement of the optical coupler 250 in the x- and y-directions, the fiducial marks may assist in precise alignment of the optical coupler in the desired location. For instance, a die bonder or flip chip bonder may observe alignment between a pair of fiducial marks (one on the substrate, the other on the optical coupler) when placing the optical coupler.

According to some embodiments, the substrate 201 may comprise, or may be formed from, silicon, silica, silicon nitride, lithium niobate, or combinations thereof.

In some embodiments, a width (e.g., size along the y-direction and/or z-direction) of one of the waveguides 205 is greater than or equal to 50 nm, 100 nm, 250 nm, 500 nm, 750 nm, or 1 μm. In some embodiments, the width of one of the waveguides 205 is less than or equal to 1.5 μm, 1 μm, 750 nm, 500 nm, 250 nm, or 100 nm. Any suitable combinations of the above-referenced ranges are also possible (e.g., the width of one of the waveguides 205 is greater or equal to 100 nm and less than or equal to 1 μm, etc.).

According to some embodiments, the optical coupler 250 comprises, or is formed from, glass (e.g., fused silica, borosilicate glass) or any other suitable reflective material. It is desirable that the optical coupler 250 has a comparatively low coefficient of thermal expansion (CTE) to mitigate warping or other effects caused by mismatched CTEs. For instance, the CTE of the optical coupler may be between 3 and 5 ppm/° C.

In some embodiments, the optical coupler 250 comprises a reflective coating on the concave surface. Optical coupler 250 may be formed from non-reflective material and have a reflective coating applied to the concave surface to produce a concave, reflective surface, or may be formed from a reflective material (e.g., glass) and an additional reflective material (e.g., metal) may be applied to the concave surface to increase reflectivity.

In some embodiments, the optical coupler 250 may have a height (greatest extent in the z-direction) greater than or equal to 5 μm, 10 μm, 15 μm, 20 μm, 25 μm, 30 μm, 35 μm, 40 μm, 45 μm, 50 μm, 55 μm or 60 μm. In some embodiments, the optical coupler 250 may have a height less than or equal to 65 μm, 60 μm, 55 μm, 50 μm, 45 μm, 40 μm, 35 μm, 30 μm, 25 μm, 20 μm, 15 μm, or 10 μm. Any suitable combinations of the above-referenced ranges are also possible (e.g., the height of the optical coupler 250 is greater or equal to 10 μm and less than or equal to 30 μm, etc.). In at least some cases, the height of the substrate 201 may limit the possible heights of the optical coupler 250, since a sufficiently large cavity may be needed to accommodate an optical coupler of a given height. In cases in which the substrate height is selected to be small enough to allow for a through silicon via (TSV) reveal process, for example, this may place an upper bound on the optical coupler's height.

In some embodiments, the optical coupler 250 may have a width (greatest extent in the x-direction) greater than or equal to 500 μm, 1 mm, 1.5 mm, or 2 mm. In some embodiments, the optical coupler 250 may have a width less than or equal to 2.5 mm, 2 mm, 1.5 mm, or 1 mm. Any suitable combinations of the above-referenced ranges are also possible (e.g., the width of the optical coupler 250 is greater or equal to 1 mm and less than or equal to 2 mm, etc.).

In some embodiments, the optical coupler 250 may have a length (greatest extent in the y-direction) greater than or equal to 1 mm, 2 mm, 5 mm or 10 mm. In some embodiments, the optical coupler 250 may have a length less than or equal to 15 mm, 10 mm, 5 mm, or 2 mm. Any suitable combinations of the above-referenced ranges are also possible (e.g., the length of the optical coupler 250 is greater or equal to 2 mm and less than or equal to 10 mm, etc.).

According to some embodiments, an illustrative process of forming the device 200 may be as follows. Initially, substrate 201 may be formed via typical wafer level high volume manufacturing techniques, including features 260. Fiducial marks 270 may be produced on the surface of the substrate via laser etching, photolithography or other suitable technique. The optical coupler 250 may be separately produced via glass molding, including the fiducial marks, concave surfaces, and mating features. The optical coupler may be optionally polished to enhance reflectivity of the concave surface(s) and/or optionally a metal coating may be added to the concave surface(s). The optical coupler may then be placed onto the substrate 201 (e.g., passively placed) and the fiducial marks on the optical coupler and substrate aligned, and the optical coupler may be then attached to the substrate with a solder reflowable adhesive through reflow soldering (e.g., with an index matching adhesive). In some cases, the placement, alignment and bonding may be performed using a die bonder or flip chip bonder system. In some embodiments, the above process may be performed at the wafer level to increase throughput for high volume manufacturing.

While the examples of FIGS. 2A-2D depicts the optical coupler 250 as being at the edge of the substrate 201, other configurations in which the optical coupler 250 is arranged within a slot within the substrate may also be envisioned. In such configurations the optical coupler would be arranged with portions of the substrate present on both sides of the coupler in the x-direction (rather than only on one side of the optical coupler as in the examples of FIGS. 2A-2D).

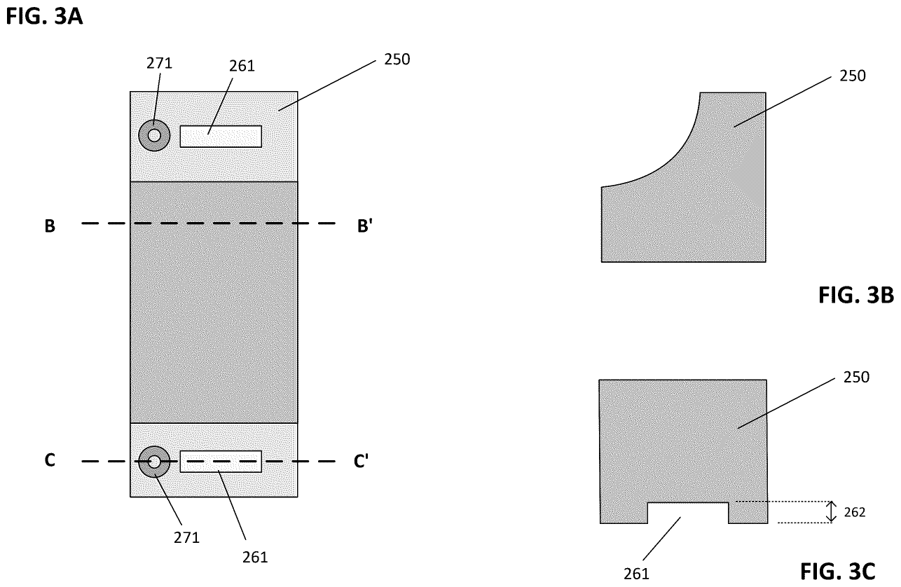

FIG. 3A depicts a top view of the optical coupler 250, according to some embodiments. FIGS. 3B and 3C depict cross-sectional views of the optical coupler 250 through cross-sections B-B′ and C-C′, respectively, as shown in FIG. 3A.

In the example of FIGS. 3A-3C, a recess 261 arranged on the underside of the optical coupler 250, as described above in relation to FIG. 2C, may be seen. In addition, fiducial marks 271 formed on an upper or lower surface of the optical coupler 250 are shown.

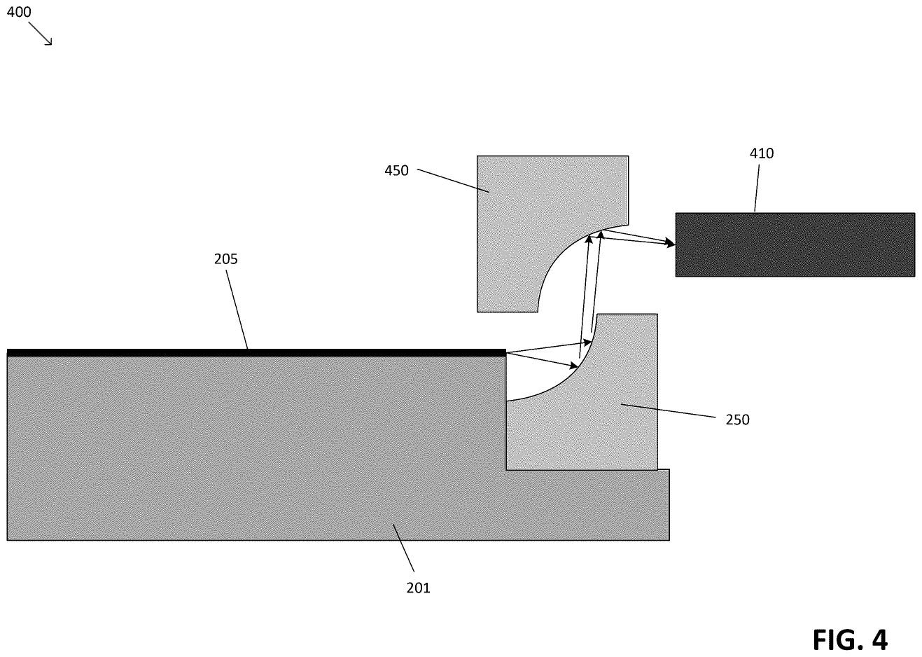

As described above, in some cases an optical coupler may be arranged in proximity to a second optical coupler to allow light to be transmitted to or from another device. FIG. 4 depicts a cross-sectional view of an illustrative system 400 that includes device 200 as shown in FIGS. 2A-2C as well as a device that includes optical coupler 450 and a photonic component 410, according to some embodiments. In some embodiments, photonic component 410 may be, or may include one or more optical fibers and/or may be, or may include, a PIC.

As shown in FIG. 4, light emitted from the waveguide 205 (e.g., from a spot size converter) may be incident on the optical coupler 250, reflected onto optical coupler 450, and reflected into (or onto) photonic component 410. Similarly, light emitted from the photonic component 410 may be incident on the optical coupler 450, reflected onto optical coupler 250, and reflected into the waveguide 205. As such, the two optical couplers enable two-way communication between the PIC that includes waveguide 205 and the photonic component 410.

In some embodiments, the optical coupler 450 may be configured to collimate the light incident on the optical coupler 450. Light from the photonic component 410 (e.g., optical fiber or fibers) may be divergent when it exits the component, and the surface shape of the optical coupler may be arranged to reduce the divergence and collimate the light. Examples of the shapes of suitable concave reflective surfaces are described above in relation to optical coupler 250, and also apply here to optical coupler 450.

According to some embodiments, optical coupler 450 may include a plurality of distinct concave reflective surfaces that are each positioned and shaped to separately reflect light incident from optical coupler 250 or to reflect light incident from photonic component 410. Such a configuration may allow, for instance, an array of waveguides to transmit light to an array of photonic components in parallel.

According to some embodiments, the optical coupler 450 comprises, or is formed from, glass (e.g., fused silica, borosilicate glass) or any other suitable reflective material. It is desirable that the optical coupler 450 has a comparatively low coefficient of thermal expansion (CTE) to mitigate warping or other effects caused by mismatched CTEs. For instance, the CTE of the optical coupler 450 may be between 3 and 5.

In some embodiments, the optical coupler 450 comprises a reflective coating on the concave surface. Optical coupler 450 may be formed from non-reflective material and have a reflective coating applied to the concave surface to produce a concave, reflective surface, or may be formed from a reflective material (e.g., glass) and an additional reflective material (e.g., metal) may be applied to the concave surface to increase reflectivity.

In some embodiments, the optical coupler 450 may have a height (greatest extent in the z-direction) greater than or equal to 5 μm, 10 μm, 15 μm, 20 μm, 25 μm, 30 μm, 35 μm, 40 μm, 45 μm, 50 μm, 55 μm or 60 μm. In some embodiments, the optical coupler 450 may have a height less than or equal to 65 μm, 60 μm, 55 μm, 50 μm, 45 μm, 40 μm, 35 μm, 30 μm, 25 μm, 20 μm, 15 μm, or 10 μm. Any suitable combinations of the above-referenced ranges are also possible (e.g., the height of the optical coupler 450 is greater or equal to 10 μm and less than or equal to 30 μm, etc.).

In some embodiments, the optical coupler 450 may have a width (greatest extent in the x-direction) greater than or equal to 500 μm, 1 mm, 1.5 mm, or 2 mm. In some embodiments, the optical coupler 450 may have a width less than or equal to 2.5 mm, 2 mm, 1.5 mm, or 1 mm. Any suitable combinations of the above-referenced ranges are also possible (e.g., the width of the optical coupler 450 is greater or equal to 1 mm and less than or equal to 2 mm, etc.).

In some embodiments, the optical coupler 450 may have a length (greatest extent in the y-direction) greater than or equal to 1 mm, 2 mm, 5 mm or 10 mm. In some embodiments, the optical coupler 450 may have a length less than or equal to 15 mm, 10 mm, 5 mm, or 2 mm. Any suitable combinations of the above-referenced ranges are also possible (e.g., the length of the optical coupler 450 is greater or equal to 2 mm and less than or equal to 10 mm, etc.).

According to some embodiments, the optical couplers 250 and 450 may exhibit the same shape and/or may be formed from the same material(s), although in other cases the couplers may differ in their shape and/or material(s).

While the depicted elements of system 400 may in some cases be permanently coupled, in other cases it may be desirable that the device including optical coupler 450 and photonic component 410 is removably connectable to the PIC to which the optical coupler 250 is attached. For example, where photonic component 410 is an optical fiber, it may be desirable that the optical fiber be capable of being plugged in to the PIC and subsequently unplugged.

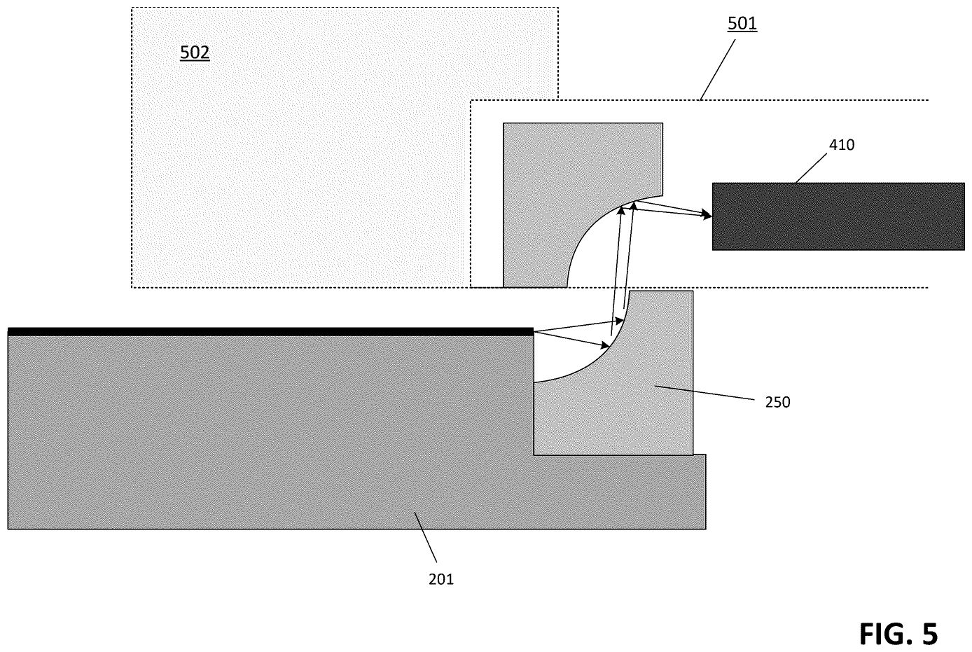

FIG. 5 depicts an example of arranging suitable connector housings around the elements of system 400 shown in FIG. 4 to allow for removable attachment between the photonic component 410 and the PIC, according to some embodiments. In the example of FIG. 5, device 200 is mechanically coupled to a housing that includes receptacle or port 502, and the photonic component 410 and optical coupler 450 are mechanically coupled to a connector housing 501 that may be removably inserted into port 502.

In the example of FIG. 5, the relative positions of port 502 and connector housing 501 may allow for precise alignment between the optical coupler 250 and optical coupler 450. For instance, fully inserting the connector housing into the port may produce a desired position of the optical coupler 250 relative to the optical coupler 450 in any one or more of the x-, y- and z-directions. In some embodiments, the optical coupler 450 and photonic component 410 may be encapsulated into a single solid material to ensure no relative movement between the optical coupler and photonic component. For example, the optical coupler 450 and photonic component 410 may be encapsulated in a block of glass.

In some embodiments, inserting the connector housing 501 into port 502 may comprise aligning the connector housing on an upper surface of a housing of the PIC and pushing the connector housing laterally along the upper surface until the connector housing engages with the port. In such implementations, as well as in other implementations, the connector housing is in contact with the upper surface of a housing of the PIC when the connector housing is engaged with the port.

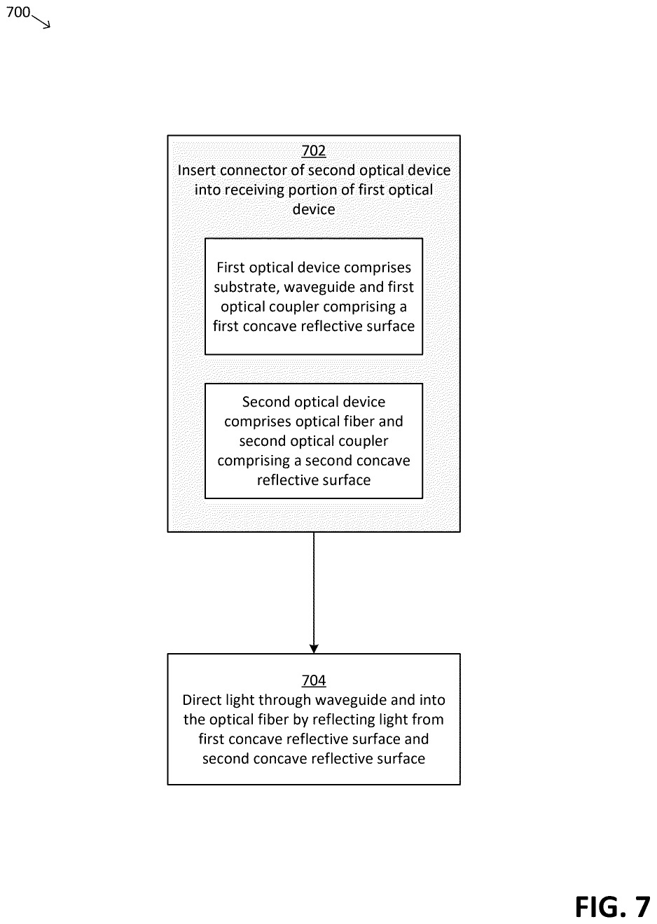

FIG. 7 depicts a flowchart of a method of coupling two optical devices, according to some embodiments. In method 700, two optical devices, such as a first optical device comprising the substrate 201 and optical coupler 250, and a second optical device comprising the photonic component 410 and connector housing 501, are coupled together. For instance, method 700 may relate to a method of aligning the components shown in FIG. 5 by mating or otherwise aligning housings of the optical devices.

In act 702, a connector (e.g., comprising connector housing 501) of a second optical device is inserted into a receiving portion of a first optical device (e.g., comprising the substrate 201 and optical coupler 250). Subsequently, in act 704 light is directed through the optical devices, such as in the manner shown in FIG. 5.

As described above, an optical coupler may include a plurality of distinct concave reflective surfaces that are each positioned and shaped to separately reflect incident light. FIG. 6A depicts a top view of a device that includes multiple waveguides and respective concave, reflective surfaces as part of an optical coupler, according to some embodiments. FIG. 6B depicts a cross-sectional view of optical coupler 650 through the axis B-B′ shown in FIG. 6A.

Device 600 shown in FIG. 6A is an instance of device 200 wherein substrate 201 includes three waveguides, and optical coupler 250 includes three respective concave, reflective surfaces, each arranged to reflect light from one of the waveguides. Moreover, device 600 is an instance of device 200 that has a particular depicted shape for the concave reflective surfaces 651, as shown in the top view in FIG. 6A, and in the cross-sectional view of FIG. 6B.

It may be appreciated that any number of waveguides and respective concave, reflective surfaces may be provided in a device such as the one shown in FIG. 6A, and that this drawings is provided merely as one illustrative example. Moreover, no fiducial marks are shown in FIG. 6A purely for clarity, and may in general be included in such a device.

According to some embodiments, a center-to-center distance 655 between adjacent concave, reflective surfaces in an optical coupler may be greater than or equal to 50 μm, 100 μm, 150 μm, 200 μm, 250 μm, or 350 μm. According to some embodiments, a center-to-center distance 655 between adjacent concave, reflective surfaces in an optical coupler may be less than or equal to 350 μm, 300 μm, 250 μm, 200 μm, 150 μm, or 100 μm. Any suitable combinations of the above-referenced ranges are also possible (e.g., a center-to-center distance 655 greater or equal to 100 μm and less than or equal to 150 μm, or a center-to-center distance 655 greater or equal to 200 μm and less than or equal to 300 μm, etc.).

In some embodiments, an optical coupler may comprise a regular array of curved, reflective surfaces each exhibiting a center-to-center distance within the above ranges.

According to some embodiments, an optical coupler may comprise an array of curved, reflective surfaces wherein the number of curved, reflective surfaces is greater than or equal to 5, 10, 25, 50, 100, 250, 500, or 1000. According to some embodiments, an optical coupler may comprise an array of curved, reflective surfaces wherein the number of curved, reflective surfaces is less than or equal to 1500, 1000, 500, 250, 100, 50, 25, or 10. Any suitable combinations of the above-referenced ranges are also possible (e.g., a number of curved, reflective surfaces is greater or equal to 10 and less than or equal to 50, or a number of curved, reflective surfaces is greater or equal to 250 and less than or equal to 1000, etc.).

The illustrative optical coupler 650 may also be utilized in a system such as that shown in FIGS. 4 and 5, wherein an optical coupler is mechanically coupled to a photonic component 410 that is arranged proximate to another optical coupler mechanically coupled to a PIC. For instance, optical coupler 650 may be deployed as both optical couplers 250 and 450 as shown in FIGS. 4 and 5 to, for instance, optically couple three optical fibers to the three waveguides 205 shown in FIG. 6A.

The above techniques may be employed in any suitable device, including any device that includes one or more photonic components, even if such device may not be considered to be a photonic integrated circuit, per se. Suitable devices may also include co-packaged optic (CPO) devices that include both electronic and photonic integrated circuits on a single packaged substrate. Any of such devices may be integrated with other components in a device, such as but not limited to: a display, user input devices, memory, one or more processors, etc.

References herein to a “concave” surface will be understood to include any recessed curved surfaces. Such a surface need not exhibit continuous curvature along all axes, or along any axes, to be considered a concave surface for practicing some of the techniques described here.

Having thus described several aspects of at least one embodiment of this invention, it is to be appreciated that various alterations, modifications, and improvements will readily occur to those skilled in the art. For instance, aspects of the techniques described herein may be combined in any of the following ways:

According to some aspects, the techniques described herein relate to a device including: a substrate including a waveguide; and an optical coupler arranged on the substrate adjacent to an end of the waveguide, the optical coupler including a concave reflective surface facing the end of the waveguide and facing away from the substrate, such that light emitted from the end of the waveguide is reflected from the concave reflective surface away from the substrate.

According to some aspects, the techniques described herein relate to a device, wherein the substrate includes a plurality of waveguides, and wherein the optical coupler includes a plurality of concave reflective surfaces each facing an end of a respective waveguide of the plurality of waveguides.

According to some aspects, the techniques described herein relate to a device, wherein the substrate includes a pedestal, wherein the optical coupler includes a recess, and wherein the optical coupler is arranged over the pedestal such that the pedestal protrudes into the recess.

According to some aspects, the techniques described herein relate to a device, wherein the concave reflective surface is arranged to produce a collimated beam from light emitted from the end of the waveguide and reflected from the concave reflective surface away from the substrate.

According to some aspects, the techniques described herein relate to a device, wherein the optical coupler has a height between 10 μm and 30 μm.

According to some aspects, the techniques described herein relate to a device, wherein the optical coupler includes glass.

According to some aspects, the techniques described herein relate to a device, wherein the optical coupler further includes a reflective coating, at least part of which forms the concave reflective surface.

According to some aspects, the techniques described herein relate to a device, wherein a center-to-center distance between adjacent concave reflective surfaces of the plurality of concave reflective surfaces is between 100 μm and 300 μm.

According to some aspects, the techniques described herein relate to a device, wherein the substrate includes one or more first fiducial marks on its upper surface, and wherein the optical coupler includes one or more second fiducial marks aligned with respective first fiducial marks of the one or more first fiducial marks.

According to some aspects, the techniques described herein relate to a device, wherein the optical coupler extends partially above an upper surface of the substrate.

According to some aspects, the techniques described herein relate to a device, wherein the concave reflective surface includes metal.

According to some aspects, the techniques described herein relate to a device, wherein the substrate includes silicon and/or silicone nitride.

According to some aspects, the techniques described herein relate to a system including: a substrate including a waveguide; an optical fiber arranged proximate to the substrate; a first optical coupler; and a second optical coupler, wherein the first optical coupler is arranged on the substrate adjacent to an end of the waveguide, and includes a first concave reflective surface facing the end of the waveguide and facing toward the second optical coupler, such that light emitted from the end of the waveguide is reflected onto the second optical coupler, and wherein the second optical coupler is arranged to reflect the light emitted from the end of the waveguide into the optical fiber.

According to some aspects, the techniques described herein relate to a system, wherein the second optical coupler is arranged adjacent to an end of the optical fiber and includes a second concave reflective surface facing the end of the optical fiber and facing toward the first optical coupler, such that light emitted from the end of the optical fiber is reflected onto the first optical coupler.

According to some aspects, the techniques described herein relate to a system, wherein light propagating through the waveguide toward the first optical coupler is reflected into the optical fiber via the first optical coupler and the second optical coupler, and wherein light propagating through the optical fiber toward the second optical coupler is reflected into the waveguide via the second optical coupler and the first optical coupler.

According to some aspects, the techniques described herein relate to a system, wherein the optical fiber and the second optical coupler are arranged within a first housing, and wherein the first housing is plugged into a receptacle coupled to the substrate.

According to some aspects, the techniques described herein relate to a system, wherein the substrate and the first optical coupler are arranged within a second housing, and wherein a lower surface of the first housing is arranged over and in contact with an upper surface of the second housing.

According to some aspects, the techniques described herein relate to a system, wherein the optical fiber and the second optical coupler are encapsulated in glass.

According to some aspects, the techniques described herein relate to a system, wherein the substrate includes a plurality of waveguides, and wherein the first optical coupler includes a plurality of concave reflective surfaces each facing an end of a respective waveguide of the plurality of waveguides.

According to some aspects, the techniques described herein relate to a system, wherein the substrate includes a pedestal, wherein the first optical coupler includes a recess, and wherein the pedestal is arranged within the recess.

According to some aspects, the techniques described herein relate to a system, wherein the substrate includes one or more first fiducial marks on its upper surface, and wherein the first optical coupler includes one or more second fiducial marks aligned with respective first fiducial marks of the one or more first fiducial marks.

According to some aspects, the techniques described herein relate to a system, wherein the first optical coupler and the second optical coupler each has a height between 10 μm and 30 μm.

According to some aspects, the techniques described herein relate to a system, wherein the first optical coupler and the second optical coupler each includes glass.

According to some aspects, the techniques described herein relate to a system, wherein the first optical coupler further includes a reflective coating, at least part of which forms the first concave reflective surface.

According to some aspects, the techniques described herein relate to a system, wherein the first concave reflective surface includes metal.

According to some aspects, the techniques described herein relate to a system, wherein the substrate includes silicon and/or silicone nitride.

According to some aspects, the techniques described herein relate to a system, including a plurality of optical fibers arranged proximate to the substrate and wherein the second optical coupler includes a plurality of concave reflective surfaces each facing an end of a respective optical fiber of the plurality of optical fibers.

According to some aspects, the techniques described herein relate to a method including: inserting a connector of a second optical device into a receiving portion of a first optical device, wherein the first optical device includes a substrate including a waveguide, and a first optical coupler arranged on the substrate adjacent to an end of the waveguide and including a first concave reflective surface, wherein the second optical device includes an optical fiber, and a second optical coupler arranged adjacent to an end of the optical fiber and including a second concave reflective surface; and subsequent to the connector of the second optical device being inserted into the receiving portion of the first optical device, directing light through the waveguide and into the optical fiber, wherein said light is reflected from the first concave reflective surface onto the second concave reflective surface, and from the second concave reflective surface into the optical fiber.

According to some aspects, the techniques described herein relate to a method, wherein subsequent to the connector of the second optical device being inserted into the receiving portion of the first optical device, the first concave reflective surface faces the end of the waveguide and faces toward the second optical coupler, and the second concave reflective surface faces the first concave reflective surface and an end of the optical fiber.

According to some aspects, the techniques described herein relate to a method, further including, subsequent to the connector of the second optical device being inserted into the receiving portion of the first optical device, directing light through the optical fiber and into the waveguide, including reflecting light from the second concave reflective surface onto the first concave reflective surface, and from the first concave reflective surface into the waveguide.

According to some aspects, the techniques described herein relate to a method, wherein inserting the connector of the second optical device into the receiving portion of the first optical device includes aligning the connector on top of a housing of the first optical device and pushing the connector laterally along the top of the housing into the receiving portion.

According to some aspects, the techniques described herein relate to a method, wherein the first optical device includes a plurality of waveguides formed in the substrate, and wherein the first optical coupler includes a plurality of concave reflective surfaces each facing an end of a respective waveguide of the plurality of waveguides.

According to some aspects, the techniques described herein relate to a method, wherein the second optical device includes a plurality of optical fibers, and wherein the second optical coupler includes a plurality of concave reflective surfaces each facing an end of a respective optical fiber of the plurality of optical fibers.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present invention may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A device comprising:
a substrate comprising a waveguide; and
an optical coupler arranged on the substrate adjacent to an end of the waveguide, the optical coupler comprising a concave reflective surface facing the end of the waveguide and facing away from the substrate, such that light emitted from the end of the waveguide is reflected from the concave reflective surface away from the substrate.

2. The device of claim 1, wherein the substrate comprises a plurality of waveguides, and wherein the optical coupler comprises a plurality of concave reflective surfaces each facing an end of a respective waveguide of the plurality of waveguides.

3. The device of claim 1, wherein the substrate comprises a pedestal, wherein the optical coupler comprises a recess, and wherein the optical coupler is arranged over the pedestal such that the pedestal protrudes into the recess.

4. The device of claim 1, wherein the concave reflective surface is arranged to produce a collimated beam from light emitted from the end of the waveguide and reflected from the concave reflective surface away from the substrate.

5. The device of claim 1, wherein the optical coupler has a height between 10 μm and 30 μm.

6. The device of claim 1, wherein the optical coupler comprises glass.

7. The device of claim 6, wherein the optical coupler further comprises a reflective coating, at least part of which forms the concave reflective surface.

8. A system comprising:
a substrate comprising a waveguide;
an optical fiber arranged proximate to the substrate;
a first optical coupler; and
a second optical coupler,
wherein the first optical coupler is arranged on the substrate adjacent to an end of the waveguide, and comprises a first concave reflective surface facing the end of the waveguide and facing toward the second optical coupler, such that light emitted from the end of the waveguide is reflected onto the second optical coupler, and
wherein the second optical coupler is arranged to reflect the light emitted from the end of the waveguide into the optical fiber.

9. The system of claim 8, wherein the second optical coupler is arranged adjacent to an end of the optical fiber and comprises a second concave reflective surface facing the end of the optical fiber and facing toward the first optical coupler, such that light emitted from the end of the optical fiber is reflected onto the first optical coupler.

10. The system of claim 8, wherein light propagating through the waveguide toward the first optical coupler is reflected into the optical fiber via the first optical coupler and the second optical coupler, and wherein light propagating through the optical fiber toward the second optical coupler is reflected into the waveguide via the second optical coupler and the first optical coupler.

11. The system of claim 8, wherein the optical fiber and the second optical coupler are arranged within a first housing, and wherein the first housing is plugged into a receptacle coupled to the substrate.

12. The system of claim 11, wherein the substrate and the first optical coupler are arranged within a second housing, and wherein a lower surface of the first housing is arranged over and in contact with an upper surface of the second housing.

13. The system of claim 8, wherein the optical fiber and the second optical coupler are encapsulated in glass.

14. The system of claim 8, wherein the substrate comprises a plurality of waveguides, and wherein the first optical coupler comprises a plurality of concave reflective surfaces each facing an end of a respective waveguide of the plurality of waveguides.

15. A method comprising:
inserting a connector of a second optical device into a receiving portion of a first optical device,
wherein the first optical device comprises a substrate comprising a waveguide, and a first optical coupler arranged on the substrate adjacent to an end of the waveguide and comprising a first concave reflective surface,
wherein the second optical device comprises an optical fiber, and a second optical coupler arranged adjacent to an end of the optical fiber and comprising a second concave reflective surface; and
subsequent to the connector of the second optical device being inserted into the receiving portion of the first optical device, directing light through the waveguide and into the optical fiber, wherein said light is reflected from the first concave reflective surface onto the second concave reflective surface, and from the second concave reflective surface into the optical fiber.

16. The method of claim 15, wherein subsequent to the connector of the second optical device being inserted into the receiving portion of the first optical device, the first concave reflective surface faces the end of the waveguide and faces toward the second optical coupler, and the second concave reflective surface faces the first concave reflective surface and an end of the optical fiber.

17. The method of claim 15, further comprising, subsequent to the connector of the second optical device being inserted into the receiving portion of the first optical device, directing light through the optical fiber and into the waveguide, comprising reflecting light from the second concave reflective surface onto the first concave reflective surface, and from the first concave reflective surface into the waveguide.

18. The method of claim 15, wherein inserting the connector of the second optical device into the receiving portion of the first optical device comprises aligning the connector on top of a housing of the first optical device and pushing the connector laterally along the top of the housing into the receiving portion.

19. The method of claim 15, wherein the first optical device comprises a plurality of waveguides formed in the substrate, and wherein the first optical coupler comprises a plurality of concave reflective surfaces each facing an end of a respective waveguide of the plurality of waveguides.

20. The method of claim 19, wherein the second optical device comprises a plurality of optical fibers, and wherein the second optical coupler comprises a plurality of concave reflective surfaces each facing an end of a respective optical fiber of the plurality of optical fibers.
